(19) United States
(12) Patent Application Publication
(10) Pub. No.: US 2026/0023842 A1
(43) Pub. Date: Jan. 22, 2026

(54) System and Method for Utilizing a Large Language Model (LLM) with Constraints Derived from Organizational Context

(71) Applicant: VARONIS SYSTEMS, INC., New York, NY (US)

(72) Inventors: John Eugene Neystadt, Kfar Saba (IL); Lior Chen, Tel Mond (IL); Liron Raveh, Pardes Hanna - Karkur (IL)

(21) Appl. No.: 18/777,596

(22) Filed: Jul. 19, 2024

(51) Int. Cl. G06F 21/45; G06N 3/0475

(52) U.S. Cl. CPC G06F 21/45; G06N 3/0475

(57) ABSTRACT

A computerized system receives an original prompt that a querying user sends to a Large Language Model (LLM) that is operably connected to organizational data sources of an organization. Instead of executing the original prompt by the LLM, the system obtains user-related organizational context that pertains to characteristics of the querying user, obtains data-related organizational context that pertains to data from which the LLM is expected to obtain information for responding to the original query, and obtains pre-defined organizational policy rules, that indicate which type of users are authorized to access which type of organizational data. Based on the obtained data, the system modifies the original prompt into an adapted prompt. The system sends the adapted prompt, and not the original prompt, to the LLM for processing. The system obtains LLM-generated output from the LLM in response to the adapted prompt, and provides that LLM-generated output to the querying user.

### FIELD

Some embodiments are related to the field of computerized systems.

### BACKGROUND

A large corporation, organization, or other entity may have thousands of team-members who utilize computing devices for various purposes; for example, to send and receive electronic mail, to engage in video calls, to browse the Internet, to compose documents, to access data repositories, or the like. Over time, such organization may accumulate a large “data lake”, which may include numerous databases, data silos, documents, files, folders, and data items.

### SUMMARY

Some embodiments include systems, devices, and methods for configuring or utilizing or operating a Large Language Model (LLM) in a constrained or restricted or filtered or grounded manner; particularly for the purpose of responding to queries from users of an organization, who submit queries to the LLM which in turn has access to an organizational data lake.

For example, an LLM may be used by a team-member to query an organizational data lake. In accordance with some embodiments, the output that is generated by the LLM and/or provided to the inquiring user is not uniform, as it depends on user-related organizational context and/or data-related organizational context. The LLM-generated output is dynamically tailored to the role of the inquiring user and/or to one or more characteristics of the inquiring user and/or to characteristics of the organization data to which the original query pertains. The tailoring is performed automatically, based on a pre-defined Selective LLM Authorization Policy that uses organizational context for selective or partial grounding/constraining of the LLM operations, or for selective filtering-in or filtering-out of data or types-of-data that this particular inquiring user is authorized to access or is unauthorized to access, and/or to dynamically perform modification/replacement/redaction of some or all of the content that the LLM generates in response to the user's query.

For example, a computerized system receives an original prompt that a querying user sends to a Large Language Model (LLM) that is operably connected to organizational data sources of an organization. Instead of executing the original prompt by the LLM, the system obtains user-related organizational context that pertains to characteristics of the querying user; and obtains data-related organizational context that pertains to data from which the LLM is expected to obtain information for responding to the original query; and obtains pre-defined organizational policy rules, that indicate which type of users are authorized to access which type of organizational data. Based on the obtained data, the system modifies the original prompt into an adapted prompt. The system sends the adapted prompt, and not the original prompt, to the LLM for processing. The system obtains LLM-generated output from the LLM in response to the adapted prompt, and provides that LLM-generated output to the querying user.

Some embodiments may provide other and/or additional benefits and/or advantages.

### BRIEF DESCRIPTION OF THE DRAWINGS

FIG. 1A is a schematic block-diagram illustration of a system, in accordance with some demonstrative embodiments.

FIG. 1B is a schematic block-diagram illustration of a system, in accordance with some demonstrative embodiments.

FIG. 1C is a schematic block-diagram illustration of a system, in accordance with some demonstrative embodiments.

FIG. 2 is a schematic block-diagram illustration of a system, in accordance with some demonstrative embodiments.

### DETAILED DESCRIPTION OF SOME DEMONSTRATIVE EMBODIMENTS

The Applicant has realized that an organization may accumulate a large volume of data, data-items, documents, email messages, electronic messages, and information stored in a variety of local and/or remote and/or cloud-based and/or on-premises repositories, databases, folders, drives, physical drives, virtual drives, data silos, Customer Relationship Management (CRM) systems, Supply Chain Management (SCM) systems, Enterprise Resource Planning (ERP) systems, and/or other information sources or data repositories, forming a “data lake” or a similar hybrid/combined/unified data repository.

The Applicant has further realized that team-members in the organization may wish to query the information, in the organizational data lake or in a particular portion thereof (e.g., only in the CRM repository or system; or only in the email mailboxes system) in order to obtain useful information that they need for their organizational tasks.

The Applicant has also realized that some team-members may utilize, or may wish to utilize, a Large Language Model (LLM) or a similar Artificial Intelligence (AI) based tool, such as a Vision and Language Model (VLM) or a Large Multi-Modal Model (LMM or LMMM) or a Large Multiple-Modalities Model (LMM or LMMM) or a Generative AI (GenAI) tool, in order to process and/or analyze such data and/or to extract or generate insights from such data that is stored in the organizational data lake or in a particular portion thereof.

The Applicant has further realized that some organizations, on the one hand, may wish to authorized some team-members to utilize an LLM or similar AI-based tools to query the organizational data lake or to generate insights therefrom; but also, on the other hand, may wish to constrain or limit the particular types of information that a particular team-member may, or may not, obtain via such tools from the organizational data lake.

For example, realized the Applicant, the same query or prompt, or similar queries or prompts, that are directed to the LLM by different team-members, should generate different outputs or differential outputs that depend, among other criteria, on an Organization Context (OC) that indicates the role or rank or position of the querying team-member, and/or other context information that may be relevant to set limits or constraints on the outputted results, and/or by taking into account a pre-defined organizational Selective LLM Authorization Policy.

For example, realized the Applicant, different team-members in an organization may submit to an intra-company/intra-organization LLM or AI tool, a query or a prompt such as, “Please generate a ten-line description of the progress of Project Alpha of our organization”. If the querying user is the CEO, realized the Applicant, then the LLM-generated output may (or should) include unconstrained or unfiltered information, including completed milestones and their costs. In contrast, realized the Applicant, if the querying user is a member of the Sales team, then the LLM-generated output should not include any financial information about the cost of development so far or about future costs, but rather, should include sales-related data or data that salespersons of the organization are generally permitted to access. Still in contrast, realized the Applicant, if the querying user is a junior member of the Quality Assurance (QA) team whose position in the organization is “Quality Assurance of Graphic User Interface”, then the LLM-generated output should further be constrained, and should include neither financial data of the project nor sales-related data of the project, and may include (at most) development-related data and/or QA-related data. Such constraints, realized the Applicant, may be represented or defined in a pre-defined organizational Selective LLM Authorization Policy.

The Applicant has realized that it may be beneficial and/or advantageous to provide a system and a computerized method that are configured to constrain, limit, define, modify, and/or otherwise control the outputs that are generated by an LLM (or other AI-based tool) when organizational team-members query an organizational data lake (or portions thereof), based on such pre-defined organizational Selective LLM Authorization Policy and based on the particular Organizational Context (OC).

The Applicant has also realized that some enterprise search systems or search tools, including (for example) Microsoft CoPilot, may enable a user to perform natural language search within organizational data lake(s). However, realized the Applicant, the introduction of such systems may pose a risk on unauthorized information access. For example, a junior assistant may be able to request from the LLM tool, “Please generate for me a list of the 50 highest-paid employees in our organization, with their names and current salary”; or, “Please provide to me at least five API keys that are currently in use by our organization's development department”.

The Applicant has realized that there is a need to perform an authorization process and/or dynamic adaptation of the information/output/results/insights that are returned to the querying user, based on the user's role/position, and/or based on data that indicates which department or team is involved and/or which particular project or task are involved, and other Organizational Context which may be important or even essential in order to securely utilize LLMs or other AI tools for querying organizational data lake(s).

The Applicant has realized that some conventional systems may utilize Grounding techniques or a firewall in an attempt to mitigate the problem. However, realized the Applicant, such conventional systems are too general and are not tailored to the role of the specific querying user or to the broader and more detailed Organizational Context that surrounds the querying user and/or his particular query. Such conventional systems, realized the Applicant, may fail to effectively block the leakage of (or the access to) sensitive information, confidential data, or other data that the querying user should not be able to access even when the user utilizes an LLM or other AI-based tool for querying the organizational data lake.

In accordance with some embodiments, an Organizational Context (OC) is gathered and defined and updated; for example, by collecting information about the particular querying user, and by classifying organizational data. The OC can be stored in a semantic index, such as a Vector Database, or in other suitable representation.

Then, one or more LLM grounding techniques can be used to send a query to the semantic index, in order to obtain the relevant OC; and then, based on a pre-defined organizational Selective LLM Authorization Policy, to generate grounding prompts or grounding prompt modifiers or filtering-in prompt modifiers or filtering-out prompt modifiers, which are then added to the actual query or query that is transferred to the LLM application.

The pre-defined organizational Selective LLM Authorization Policy may restrict or may define which particular users or types-of-users (e.g., based on user roles, user positions, position titles, department members, project team-members) can or cannot access particular types of information (e.g., financial data, sales data, employee compensation data, password/credentials data), based on sensitivity, confidentiality constrains, legal constrains of the organization (such as HIPAA for health services or medical services providers), semantic classification and/or project relatedness; and may cause either Blocking of the information or Adaptation/Adapting/Modification of the information that is outputted to that querying user. The adaptation may include, for example, an instruction to LLM (e.g., as a prompt modifier or a prompt add-on) to generalize information, to aggregate information, to mask or remove particular types of information, or to otherwise omit or mask information that this particular querying user-based on the Organizational Context and the pre-defined organizational Selective LLM Authorization Policy—is not authorized to view or access or use.

In a demonstrative implementation, the pre-defined organizational Selective LLM Authorization Policy may include a set of rules or conditions or definitions, or filtering-in rules or filtering-out rules, such as the following non-limiting examples.

Demonstrative Rule 1, Adapt: Remove [classification]=confidential, when [data.department]!=[user.department]. For example, a data-item having a classification of “confidential”, will be Removed from the output if (or when) the department to which the user belongs is different from the department to which the data-item belongs. For example, if a Programmer is attempting to query about confidential Sales data, then the confidential sales data would be blocked/omitted/removed/redacted/masked. It is noted that according to this demonstrative rule, if a Programmer is attempting to query about non-confidential Sales data, then this rule does not block the data; for example, the Programmer may be querying about a publicly-available Sales Brochure in order to check what is the exact sales term for a particular feature of the product.

Demonstrative Rule 2, Block: Access to [classification]=secrets, except for [department]=DevOps. For example, this Rule blocks access to any data-item that is classified as “secret” or “confidential”, if the querying user does Not belong to the DevOps team.

Demonstrative Rule 3, Adapt: Remove [classification]=financials for all, except [department]=finance management or sales management. For example, this Rule adapts or modifies the output generated by the LLM and/or that is provided to the querying user, such that any data-item that is classified as “financial” is removed or redacted or masked or omitted for all querying users, except for those who are members of the Sales Management team or the Finance Management team. The financial data would be removed or masked or omitted, for example, for a querying user who is a Senior Programmer, or who is a Junior Salesperson; but not for the Chief Marketing Officer.

Demonstrative Rule 4, Adapt: Remove dates for [classification]=product plans, except [department]=engineering. For example, this Rule removes from the LLM-generated output all dates (e.g., calendar dates; or date-related terms or information such as “by the end of Year 2025”) that appear in Product Plans, for all querying users, except for users from the engineering department.

Demonstrative Rule 5, Block: Block the access to [classification]=salary, except for [user.role]=VP. For example, this Rule blocks the access to data-items that are classified as “salary” (or compensation, or wages, or paycheck, or similar tag or indicator), for all querying users, except for querying users having a role of Vice President. In some embodiments, a Rule or a Meta-Rule may be used such that an operator of “equal” would be construed/implemented as “equal or greater than”; such that, a Rule that permits a Vice President to access salaries of employees, further allows automatically also roles that are defined as “greater than” or “superior to” that role, such as the President or the CEO of the organization.

In a demonstrative implementation, the system and the computerized method of some embodiments may provide the following non-limiting examples of outputs or outcomes, based on a particular pre-defined organizational Selective LLM Authorization Policy.

Demonstrative example 1: The querying user requests the LLM/AI-based tool, “Please give me passwords and API keys”; if the querying user is a DevOps team-member, then he is authorized to access files with keys/passwords and this request is not blocked; but for other querying users, the system blocks the LLM/AI-based tool from returning such information (action=block).

Demonstrative example 2: The querying user requests the LLM/AI-based tool, “Please give me the list of customers that have a license for our Product X”; the system provides the list of customers, without financial data (e.g., without indicating the price that each of those customers paid for that license of that product); except that if the querying user belongs to the Finance Management team or to the Sales Management team, then such financials data would also be included in the outputs (action=adapt).

Demonstrative example 3: The querying user requests the LLM/AI-based tool, “Please tell me what are the roadmap features”; in response, if the querying user belongs to the Engineering department, then the output can/would include dates; whereas, if the querying user belongs to the Sales department, then the roadmap features would be provided without timeline (action=adapt).

Demonstrative example 4: The querying user requests the LLM/AI-based tool, “Please tell me which security incidents did customer Y have in 2024”; in response, if the querying user belongs to the Cyber Security team or to the Managed Detection and Response (MDR) team, then the output would include all/full details of such security incidents; whereas other team-members of the same department (e.g., Engineering) or of other departments (e.g., Sales) would get output that shows only the number of incident, without further details (action=adapt). Additionally, if the role or task of the querying user does not appear in the Policy as justifying access to such information, such as if the querying user is a Junior QA person whose role is to perform QA of GUI elements, then such data may be entirely blocked for him (action=block).

Demonstrative example 5: The querying user requests the LLM/AI-based tool, “Please provide me a list of all our suppliers/vendors”; in response, the list of suppliers/vendors is available as part of the output to all querying users, but the actual response or the output is adapted or modified to redact (remove, mask, delete, omit, adapt) amounts that were paid to each vendor, as such data is only available to (is only accessible by) team-members of the Procurement department or the Accounting department.

Demonstrative example 6: The querying user requests the LLM/AI-based tool, “Please give me list of ex-employees who left our organization in 2023, with the reason for the separation from each of them”; in response, the list of such ex-employees can be part of the output that is generated/provided to all querying users who are Managers or that are part of the Human Resources (HR) department; whereas reason for separation (e.g., employee was terminated, employee resigned due to personal reason, employee resigned because he moved to another country) can be redacted or omitted (action=adapt), unless the querying user is a member of the Human Resources department or the Legal department.

Demonstrative example 7: The querying user requests the LLM/AI-based tool, “Please provide to me a list of current employees that you estimated, based on your LLM-based analysis of their emails/communications/documents, that they are considering to leave the organization or that they are at risk of leaving the organization); in response, the system allows such output to be generated/to be provided to the querying user, only with regard to current employees that report directly (and/or indirectly) to that particular querying user (action=adapt).

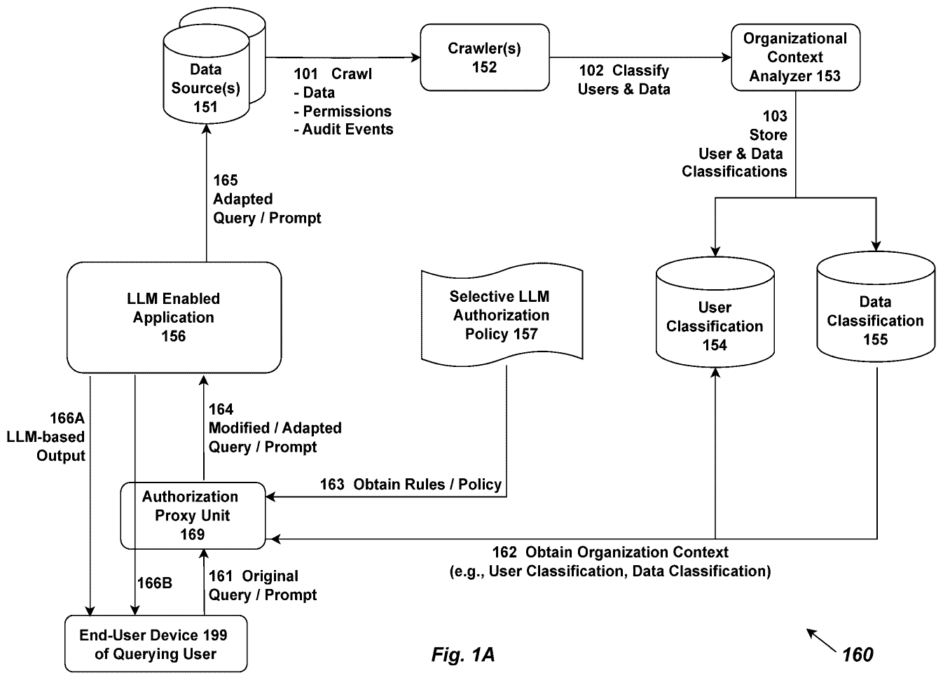

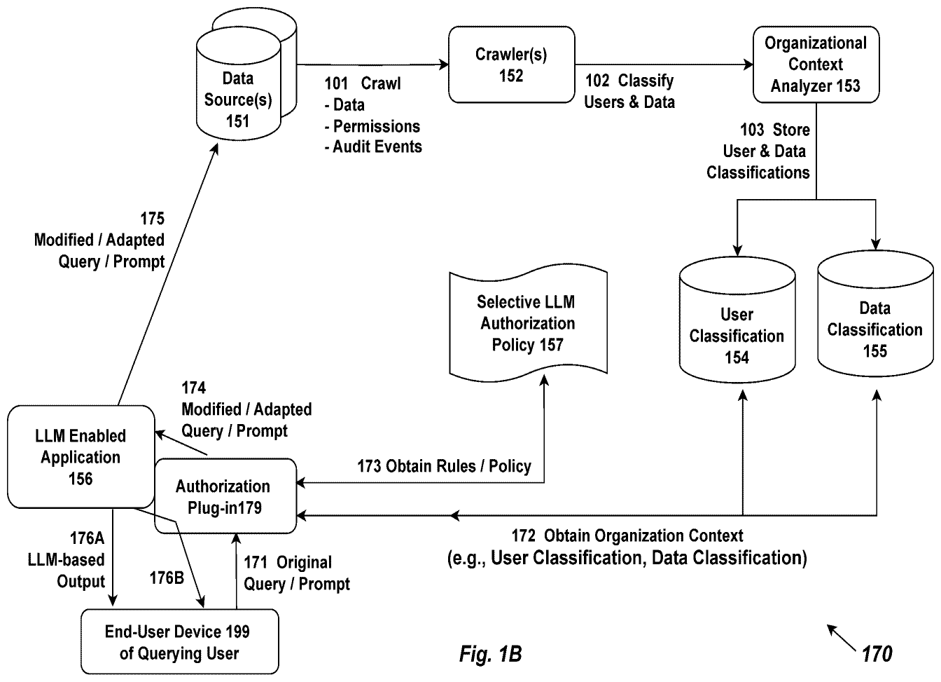

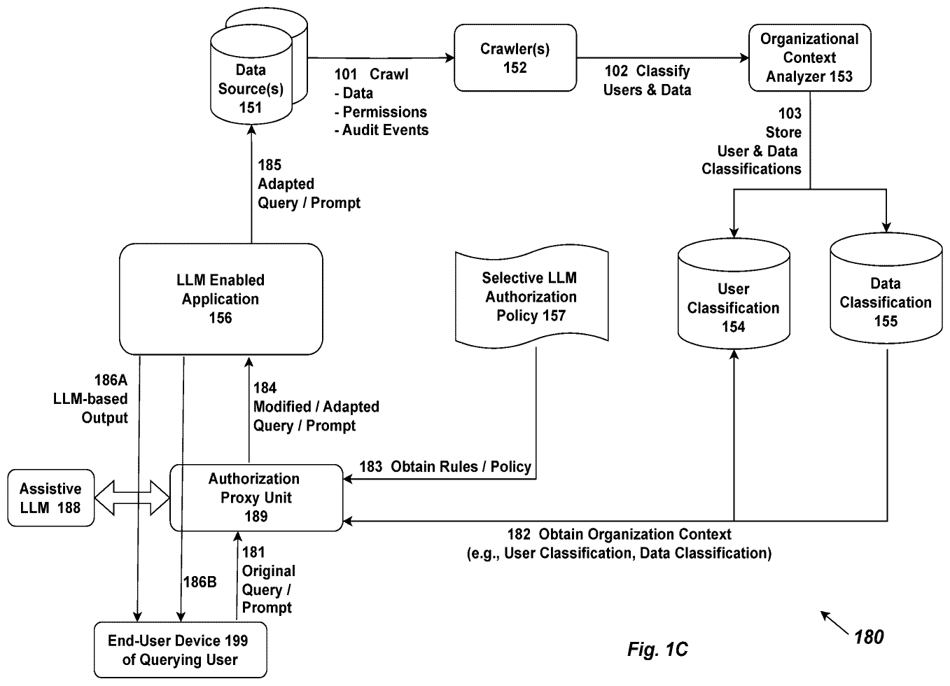

Reference is made to FIGS. 1A to IC, which are schematic block-diagram illustrations of three systems (160, 170, 180) in accordance with some demonstrative embodiments. These or similar systems may be implemented using hardware components and/or software components; and may include local/on-premises units or modules, remote/cloud-based units or modules, or a combination thereof. The three demonstrative systems (160, 170, 180) may include a set of components that is the same for all of them, and is discussed herein firstly; and may further include a different set of components that will be discussed later herein for each of those systems.

Referring firstly to the components that can be included in each of systems 160/170/160, the system may include one or more Data Sources 151, such as data lake(s), data silo(s), databases, CRM systems, SCM systems, ERM systems, email systems, instant messaging systems, group messaging systems, files, documents, folders, physical drives, virtual drives, textual items, graphical items, video items, audio items, presentations, received/incoming communication messages, sent/outgoing communication messages, data about organizational structure (e.g., employee directory, organizational chart), and/or other data-items or information that is available to at least some team-members of the organization.

The organizational Data Sources 151 undergo a process of Organizational Context Indexing; which may be performed one time, or repeatedly, or continuously, or at particular time-points (e.g., the first Sunday of every week) or at particular time-intervals (e.g., every 10 days); and/or which may include dynamic and/or periodical updating of such OC indexing (e.g., every day, every week, upon an update to a particular data silo, based on a pre-defined condition or event such as introduction of a new data silo or information system, or the like).

For example, as indicated in Step 101 of the OC indexing process, one or more Crawlers 152 (e.g., crawling units, crawling modules) perform scanning and indexing of the organizational Data Sources 151; such as, extracting data (e.g., “User Adam is a Manager in the Marketing Department”), extracting permissions (e.g., “VP Finance is authorized to access all financial records”), and extracting and audit events (namely, which user/team-member/role had accessed which particular data-item or data-type; such as, “VP Sales has accessed Sales Data of year 2023”, and “Junior Programmer has accessed a repository of stock images for website development”).

As indicated in Step 102 of the OC indexing process, an Organization Context Analyzer unit 153 then processes the information that was crawled/extracted/collected by the Crawler(s) 152. For example, the Organization Context Analyzer unit 153 classifies the files (or documents, or messages, or data-items) based on content (e.g., Marketing related; Sales related; R&D related; Legal related; Finance related), and assigns one or more projects/departments that are relevant to that item based on which users in the organization have already accessed that item according to audit events (e.g., “Budget-2024.xls was accessed by all Manager positions in Finance department, and by all Senior Manager positions in Marketing department”). Additionally, the Organization Context Analyzer unit 153 classifies users based on data about them as obtained from organizational directory, organizational chart, Human Resources (HR) data or systems (e.g., “User Adam is a Senior Manager in the Marketing Department”, or “User Becky is a Junior Developer in the R&D Department”), and/or based on similarity of data or data-items that the user has accessed together with other known users or peers (e.g., deducing or observing that User Adam has accessed 14 out of 17 documents that were authored/saved/composed/modified by User Carl; and that User Becky has never accessed any of the 17 documents that were authored/saved/composed/modified by User Carl).

As indicated in Step 103, the classifications are stored in a Semantic Index, such as a Vector Database, enabling the system to later fetch or obtain the relevant classification(s) based on name (or other characteristic) of the user, the name (or other characteristic) of the relevant project, the file name, or other extracted and indexed characteristics. For demonstrative purposes, the Semantic Index is shown as User Classification 154 and as Data Classification 155.

The system (160, 170, 180) further comprises an LLM-Enabled Application 156, which may be a locally-running or a cloud-based application that utilizes an LLM, or other Gen-AI or AI-based tool or tools, to generate output or insights based on a prompt/query. The LLM-Enabled Application 156 may be a generally-trained LLM, or an LLM that was trained or re-trained or fine-tuned particularly on some or all of the data/documents/information that the organization has in some or all of its Data Sources 151. Some embodiments may utilize, for example, a Microsoft Co-Pilot LLM, an OpenAI ChatGPT LLM, a Meta Llama LLM, a Google Gemini LLM, an Anthropic Claude LLM, a Vision and Language Model (VLM), a large multiple-modalities model, or the like. In some embodiments, optionally, the LLM-Enabled Application 156 may actually be a cascade or chain or series of several LLMs (e.g., a first LLM that was particularly trained or re-trained or fine-tuned on Financial information; a second LLM that was particularly trained or re-trained on Technological information; a third LLM that was particularly trained or re-trained or fine-tuned on Medical information; and so forth), optionally with a Controller LLM or a Master LLM that allocates queries among the various LLMs and/or the collects and arbitrates outputs from such plurality of LLMs.

Additionally, the system (160, 170, 180) includes a pre-defined organizational Selective LLM Authorization Policy 157, that indicates (a) which users or types-of-users, or which users having particular characteristics, are authorized to access, or are unauthorized to access, (b) which documents/data-items, or which particular type of documents/data-items. The pre-defined organizational Selective LLM Authorization Policy 157 may indicate, for example: that Senior Managers in the Marketing Department are authorized to access any Marketing information, and are not authorized to access any HR information except for HR information of their subordinates; or, that Junior Developers in the R&D Department are authorized to access only Test Code Repository A, and not Production Code Repository B; or, that members of Project Alpha are authorized to access documents or data-items that belong to Project Alpha, and not to other projects; and so forth, based on user characteristics and data-item characteristics (or data characteristics).

Further shown is an End-User Device 199, such as a laptop computer or a desktop computer, or a smartphone or table or portable computing device, that an end-user (“the querying user”) utilizes to type or compose or enter or otherwise provide a Query/Prompt that is intended to be directed to the LLM-Enabled Application 156.

There may be different implementations, in accordance with various embodiments, with regard to how the system operates as an Adaptive LLM Query System that takes into account user-related OC and data-related OC, as well as the relevant rules from the pre-defined organizational Selective LLM Authorization Policy 157. For demonstrative purposes, here is an overview of several such implementations.

In a first demonstrative implementation, the original query of the querying user is not routed directly to the LLM-Enabled Application 156; but rather, is routed to an Authorization Proxy Unit, which firstly obtains the relevant user-related OC, the relevant data-related OC, and the relevant rules from the pre-defined organizational Selective LLM Authorization Policy 157. The Authorization Proxy Unit then modifies the original query into an adapted query, and sends the adapted query to the LLM-Enabled Application 156. In a first variant of this implementation, the LLM-Enabled Application 156 generates output based on the adapted query; and sends the output back directly to the querying user; in this variant, the adapted query is regarded as sufficient to serve the goals of the organization with regard to access control to sensitive information. In a second variant of this implementation, the LLM-Enabled Application 156 generates output based on the adapted query, but sends its output to the Authorization Proxy Unit, which checks again whether or not the LLM-based output complies with the relevant rules of the pre-defined organizational Selective LLM Authorization Policy 157, and blocks or removes or deletes or masks or deletes one or more portions of the LLM-based output that do not comply with such relevant rules, and only then transfers the modified LLM-based output to the querying user; thereby providing dual-stage protection against access to sensitive information, the first stage prior to the LLM processing and the second stage subsequent to the LLM processing.

In a second demonstrative implementation, the original query of the querying user is routed directly to the LLM-Enabled Application 156, which is accompanies by an Authorization Plug-in, which firstly obtains the relevant user-related OC, the relevant data-related OC, and the relevant rules from the pre-defined organizational Selective LLM Authorization Policy 157. The Authorization Plug-in then modifies the original query into an adapted query, and provides the adapted query to the LLM-Enabled Application 156. In a first variant of this implementation, the LLM-Enabled Application 156 generates output based on the adapted query; and sends the output back directly to the querying user; in this variant, the adapted query is regarded as sufficient to serve the goals of the organization with regard to access control to sensitive information. In a second variant of this implementation, the LLM-Enabled Application 156 generates output based on the adapted query, but sends its output to the Authorization Plugin, which checks again whether or not the LLM-based output complies with the relevant rules of the pre-defined organizational Selective LLM Authorization Policy 157, and blocks or removes or deletes or masks or deletes one or more portions of the LLM-based output that do not comply with such relevant rules, and only then transfers the modified LLM-based output to the querying user; thereby providing dual-stage protection against access to sensitive information, the first stage prior to the LLM processing and the second stage subsequent to the LLM processing.

In a third demonstrative implementation, the original query of the querying user is not routed directly to the LLM-Enabled Application 156; but rather, is routed to an Authorization Proxy Unit, which firstly obtains the relevant user-related OC, the relevant data-related OC, and the relevant rules from the pre-defined organizational Selective LLM Authorization Policy 157. The Authorization Proxy Unit then provides to an Assistive LLM the original query, as well as the user-related OC and the data-related OC and the relevant rules from the pre-defined organizational Selective LLM Authorization Policy 157. The Assistive LLM is prompted to generate an Adapted Query, that it returns to the Authorization Proxy Unit. Then, the Authorization Proxy Unit sends the adapted query to the LLM-Enabled Application 156. In a first variant of this implementation, the LLM-Enabled Application 156 generates output based on the adapted query; and sends the output back directly to the querying user; in this variant, the adapted query is regarded as sufficient to serve the goals of the organization with regard to access control to sensitive information. In a second variant of this implementation, the LLM-Enabled Application 156 generates output based on the adapted query, but sends its output to the Authorization Proxy Unit, which checks again whether or not the LLM-based output complies with the relevant rules of the pre-defined organizational Selective LLM Authorization Policy 157, and blocks or removes or deletes or masks or deletes one or more portions of the LLM-based output that do not comply with such relevant rules, and only then transfers the modified LLM-based output to the querying user; thereby providing dual-stage protection against access to sensitive information, the first stage prior to the LLM processing and the second stage subsequent to the LLM processing. In a third variant of this implementation, the output of the LLM-Enabled Application 156 is transferred to the Assistive LLM, which checks that output against the relevant rules from the pre-defined organizational Selective LLM Authorization Policy 157, and further adapts or modifies the output (that was originally generated by the LLM-Enabled Application 156) in view of such rules; and only then, the adapted/modified output is sent back to the querying user, via the Authorization Proxy Unit.

The above are some non-limiting examples of implementations and variants, that can be configured and deployed in accordance with some embodiments. Other suitable configurations or architectures may be used.

Reference is made now to FIG. 1A, describing the particular components of its System 160 that operates as an Adaptive LLM Query System.

As indicated in Step 161, the querying user utilizes his end-user device 199 to submit his original query, typically as text in a natural language (e.g., English, Spanish, or the like). Optionally, the query may further include or attach one or more files or attachments, to provide further context to this particular query (e.g., “Please tell me which of the employees that are listed in Attachmend.docx has an annual salary that is greater than 75,000 dollars”).

An Authorization Proxy Unit 169 is deployed in front of the LLM-Enabled Application 156, or before the LLM-Enabled Application 156, or on the path/route between the end-user device 199 of the querying user and the LLM-Enabled Application 156.

In accordance with some embodiments, the roles of the Authorization Proxy Unit 169 may include some, or most, or all, of the following: (a) to obtain user-related OC and data-related OC; (b) to obtain relevant rules from the pre-defined organizational Selective LLM Authorization Policy 157; (c) if the pre-defined organizational Selective LLM Authorization Policy 157 indicates that the relevant action is “block”, then, to entirely block the original query from reaching the LLM-Enabled Application 156, and instead to return a response to the querying user indicating that the original query was blocked due to organizational policy; (d) if the pre-defined organizational Selective LLM Authorization Policy 157 indicates that the relevant action is “adapt”, then, to adapt or modify the original query based on the relevant rule and the relevant user-related OC and data-related OC; (e) in case of query adaptation, to generate and to add to the original query, for example, one or more grounding rules or constraining rules or filtering-out rules or filtering-in rules, or one or more prompt modifiers or prompt add-ons or prompt grounding elements or prompt constraining elements; (f) in case of query adaptation, to generate and to add to the original query, for example, an indication of the particular rules that should be applied to this query from the pre-defined organizational Selective LLM Authorization Policy 157; (g) in case of query adaptation, to add to the original query, for example, representation of the user-related OC and the data-related OC; (f) to review and analyze the LLM-generated output in order to check whether or not it complies with the relevant rules from the pre-defined organizational Selective LLM Authorization Policy 157, and if not, to remove/delete/mask non-complying information or sensitive information, or to otherwise adapt or modify the LLM-based output to make it compliant with those rules.

For example, as indicated in Step 162, the Authorization Proxy Unit 169 uses the original query (including its data/content, and its meta-data, such as who is the querying user, what is the role/title/position of the querying user, or the like) and obtains the relevant Organizational Context from the semantic database(s) about user classification and data classification.

As indicated in Step 163, the Authorization Proxy Unit 169 utilizes the user-related OC and the data-related OC, and further utilizes the relevant rules from the pre-defined organizational Selective LLM Authorization Policy 157, to generate one or more Prompt Modifiers or Prompt Add-Ons, one or more filtering-out prompt modifiers or add-ons (e.g., that would specifically notify the LLM which data-items are not authorized to be included in the LLM-based output, or which data-items must be removed or masked or omitted or excluded from the LLM-based output), one or more filtering-in prompt modifiers or add-ons (e.g., that would specifically notify the LLM which data-items are authorized to be included in the LLM-based output), or other grounding rules or grounding prompt add-ons.

In accordance with some embodiments, if the pre-defined organizational Selective LLM Authorization Policy 157 indicates that the action that should be taken, for this particular user OC and data OC, is an action of “adapt”, then: the Authorization Proxy Unit 169 generates the relevant filtering-out/filtering-in/grounding/constraining prompt modifiers or prompt add-ons; and adds them to the original query/prompt; and optionally adds the user-related and data-related OC; and sends (Step 164) the modified/adapted prompt to the LLM-Enabled Application 156, which in turn performs the LLM-based analysis (Step 165) by utilizing the adapted queries to query the Data Sources 151, and returns LLM-based output to the end-user device 199 of the querying user (Step 166A or 166B). In a first variant of this implementation, the LLM-based output is sent back from the LLM-Enabled Application 156 to the querying user (Step 166A), without additional filtering or screening or adaptation or modification; since the LLM-Enabled Application 156 has already operated based on an adapted query. In a second variant of this implementation, the LLM-based output is sent from the LLM-Enabled Application 156 to the Authorization Proxy Unit 169, which performs another iteration of data adaptation or sanitizing by checking whether or not the LLM-based output complies with the relevant rules in the pre-defined organizational Selective LLM Authorization Policy 157, and to mask or delete or conceal or remove data-portions that do not comply with those rules; and only then, the Authorization Proxy Unit 169 sends (Step 166B) to the querying user the LLM-based output that was possibly further modified/adapted by the Authorization Proxy Unit 169 based on those rules.

In contrast, if the pre-defined organizational Selective LLM Authorization Policy 157 indicates that the action that should be taken, for this particular user OC and data OC, is an action of “block”, then: the Authorization Proxy Unit 169 blocks the original query/prompt of the querying user, and does not send it (does not forward it, does not relay it) to the LLM-Enabled Application 156; and optionally, the Authorization Proxy Unit 169 sends a response to the querying user indicating that this query was blocked due to an organizational policy.

In some embodiments, optionally, the output of the LLM-Enabled Application 156 is not transferred directly or immediately to the querying user; but rather, the LLM output is checked against the relevant rules from the pre-defined organizational Selective LLM Authorization Policy 157, in view of the relevant user-related OC and data-related OC, to further ensure that the LLM output complies with the relevant rules and does not provide to the querying user any sensitive information that the pre-defined organizational Selective LLM Authorization Policy 157 does not allow to provide. In some embodiments, the LLM output is thus further adapted/modified/filtered/sanitized prior to its actual deliver to the querying user, based on those rules and in view of the user-related OC and data-related OC.

Reference is made now to FIG. 1B, describing the particular components of its System 170 that operates as an Adaptive LLM Query System.

As indicated in Step 171, the querying user utilizes his end-user device 199 to submit his original query, typically as text in a natural language (e.g., English, Spanish, or the like). Optionally, the query may further include or attach one or more files or attachments, to provide further context to this particular query (e.g., “Please tell me which of the employees that are listed in Attachmend.docx has an annual salary that is greater than 75,000 dollars”).

The original query is conveyed from the querying user to the LLM-Enabled Application 156; however, the original query is not immediately processed at the LLM-Enabled Application 156, and is not processed “as is” at the LLM-Enabled Application 156. Rather, the LLM-Enabled Application 156 equipped with, or comprises, or is operably coupled to, or is configured to operate in conjunction with, an Authorization Plug-in 179.

In accordance with some embodiments, the roles of the Authorization Plus-in 179 may include some, or most, or all, of the following: (a) to obtain user-related OC and data-related OC; (b) to obtain relevant rules from the pre-defined organizational Selective LLM Authorization Policy 157; (c) if the pre-defined organizational Selective LLM Authorization Policy 157 indicates that the relevant action is “block”, then, to entirely block the original query from reaching the LLM-Enabled Application 156, and instead to return a response to the querying user indicating that the original query was blocked due to organizational policy; (d) if the pre-defined organizational Selective LLM Authorization Policy 157 indicates that the relevant action is “adapt”, then, to adapt or modify the original query based on the relevant rule and the relevant user-related OC and data-related OC; (e) in case of query adaptation, to generate and to add to the original query, for example, one or more grounding rules or constraining rules or filtering-out rules or filtering-in rules, or one or more prompt modifiers or prompt add-ons or prompt grounding elements or prompt constraining elements; (f) in case of query adaptation, to generate and to add to the original query, for example, an indication of the particular rules that should be applied to this query from the pre-defined organizational Selective LLM Authorization Policy 157; (g) in case of query adaptation, to add to the original query, for example, representation of the user-related OC and the data-related OC; (f) to review and analyze the LLM-generated output in order to check whether or not it complies with the relevant rules from the pre-defined organizational Selective LLM Authorization Policy 157, and if not, to remove/delete/mask non-complying information or sensitive information, or to otherwise adapt or modify the LLM-based output to make it compliant with those rules.

For example, as indicated in Step 172, the Authorization Plug-in 179 uses the original query (including its data/content, and its meta-data, such as who is the querying user, what is the role/title/position of the querying user, or the like) and obtains the relevant Organizational Context from the semantic database(s) about user classification and data classification.

As indicated in Step 173, the Authorization Plug-in 179 utilizes the user-related OC and the data-related OC, and further utilizes the relevant rules from the pre-defined organizational Selective LLM Authorization Policy 157, to generate one or more Prompt Modifiers or Prompt Add-Ons, one or more filtering-out prompt modifiers or add-ons (e.g., that would specifically notify the LLM which data-items are not authorized to be included in the LLM-based output, or which data-items must be removed or masked or omitted or excluded from the LLM-based output), one or more filtering-in prompt modifiers or add-ons (e.g., that would specifically notify the LLM which data-items are authorized to be included in the LLM-based output), or other grounding rules or grounding prompt add-ons.

In accordance with some embodiments, if the pre-defined organizational Selective LLM Authorization Policy 157 indicates that the action that should be taken, for this particular user OC and data OC, is an action of “adapt”, then: the Authorization Plug-in 179 generates the relevant filtering-out/filtering-in/grounding/constraining prompt modifiers or prompt add-ons; and adds them to the original query/prompt; and optionally adds the user-related and data-related OC; and sends (Step 174) the modified/adapted prompt to the co-located or the operably coupled LLM-Enabled Application 156, which in turn performs the LLM-based analysis (Step 175) by utilizing the adapted query to query the Data Sources 151, and returns LLM-based output to the end-user device 199 of the querying user (Step 176A or 176B). In a first variant of this implementation, the LLM-based output is sent back from the LLM-Enabled Application 156 to the querying user (Step 176A), without additional filtering or screening or adaptation or modification; since the LLM-Enabled Application 156 has already operated based on an adapted query. In a second variant of this implementation, the LLM-based output is sent from the LLM-Enabled Application 156 to the Authorization Plug-in 179, which performs another iteration of data adaptation or sanitizing by checking whether or not the LLM-based output complies with the relevant rules in the pre-defined organizational Selective LLM Authorization Policy 157, and to mask or delete or conceal or remove data-portions that do not comply with those rules; and only then, the Authorization Plug-in 179 sends (Step 176B) to the querying user the LLM-based output that was possibly further modified/adapted by the Authorization Plug-in 179 based on those rules.

In contrast, if the pre-defined organizational Selective LLM Authorization Policy 157 indicates that the action that should be taken, for this particular user OC and data OC, is an action of “block”, then: the Authorization Plug-in 179 blocks the original query/prompt of the querying user, and does not send it (does not forward it, does not relay it) to the LLM-Enabled Application 156; and optionally, the Authorization Plug-in 179 sends a response to the querying user indicating that this query was blocked due to an organizational policy.

In some embodiments, optionally, the output of the LLM-Enabled Application 156 is not transferred directly or immediately to the querying user; but rather, the LLM output is checked against the relevant rules from the pre-defined organizational Selective LLM Authorization Policy 157, in view of the relevant user-related OC and data-related OC, to further ensure that the LLM output complies with the relevant rules and does not provide to the querying user any sensitive information that the pre-defined organizational Selective LLM Authorization Policy 157 does not allow to provide. In some embodiments, the LLM output is thus further adapted/modified/filtered/sanitized prior to its actual deliver to the querying user, based on those rules and in view of the user-related OC and data-related OC.

Reference is made now to FIG. 1C, describing the particular components of its System 180 that operates as an Adaptive LLM Query System. System 180 of FIG. 1C may be generally similar to System 160 of FIG. 1A; however, in System 180, the Authorization Proxy Unit 169 is operably accompanied by, or operates in conjunction with, or is being operably assisted by, an Assistive LLM 188.

For example, the Assistive LLM 188 may be a different/separate LLM from the LLM of the LLM-Enabled Application 156. The Assistive LLM 188 may be particular trained or re-trained or fine-tuned in the field or fields of: (a) generating grounding/constraining/limiting/authorizing/non-authorizing prompt add-ons or prompt modifiers; and/or (b) modifying or adapting an original query or an original prompt, into an adapted/modified prompt that takes into account constraints imposed by rules from a pre-defined organizational Selective LLM Authorization Policy 157, and further based on user-related OC and data-related OC; and/or (c) checking whether or not LLM output (that was generated by another LLM, such as the LLM-Enabled Application 156) is compliant with one or more data sensitivity rules, data leakage prevention rules, data access control rules, rules from the pre-defined organizational Selective LLM Authorization Policy 157, and then, further adapting/filtering/blocking/modifying such LLM-generated output to comply or to better comply with such rules, and/or deleting/masking/removing one or more data-portions or data-segments or strings from the LLM-based output to comply or to better comply with such rules prior to delivery of such adapted output to the querying user.

As indicated in Step 181, the querying user utilizes his end-user device 199 to submit his original query, typically as text in a natural language (e.g., English, Spanish, or the like). Optionally, the query may further include or attach one or more files or attachments, to provide further context to this particular query (e.g., “Please tell me which of the employees that are listed in Attachmend.docx has an annual salary that is greater than 75,000 dollars”).

An Authorization Proxy Unit 189 is deployed in front of the LLM-Enabled Application 156, or before the LLM-Enabled Application 156, or on the path/route between the end-user device 199 of the querying user and the LLM-Enabled Application 156.

In accordance with some embodiments, the roles of the Authorization Proxy Unit 189 may include some, or most, or all, of the following roles, and they may be performed entirely or in part by the Assistive LLM 188, or may be further adapted or modified by the Assistive LLM 188: (a) to obtain user-related OC and data-related OC; (b) to obtain relevant rules from the pre-defined organizational Selective LLM Authorization Policy 157; (c) if the pre-defined organizational Selective LLM Authorization Policy 157 indicates that the relevant action is “block”, then, to entirely block the original query from reaching the LLM-Enabled Application 156, and instead to return a response to the querying user indicating that the original query was blocked due to organizational policy; (d) if the pre-defined organizational Selective LLM Authorization Policy 157 indicates that the relevant action is “adapt”, then, to adapt or modify the original query based on the relevant rule and the relevant user-related OC and data-related OC; (e) in case of query adaptation, to generate and to add to the original query, for example, one or more grounding rules or constraining rules or filtering-out rules or filtering-in rules, or one or more prompt modifiers or prompt add-ons or prompt grounding elements or prompt constraining elements; (f) in case of query adaptation, to generate and to add to the original query, for example, an indication of the particular rules that should be applied to this query from the pre-defined organizational Selective LLM Authorization Policy 157; (g) in case of query adaptation, to add to the original query, for example, representation of the user-related OC and the data-related OC; (f) to review and analyze the LLM-generated output in order to check whether or not it complies with the relevant rules from the pre-defined organizational Selective LLM Authorization Policy 157, and if not, to remove/delete/mask non-complying information or sensitive information, or to otherwise adapt or modify the LLM-based output to make it compliant with those rules.

For example, as indicated in Step 182, the Authorization Proxy Unit 169 uses the original query (including its data/content, and its meta-data, such as who is the querying user, what is the role/title/position of the querying user, or the like) and obtains the relevant Organizational Context from the semantic database(s) about user classification and data classification.

As indicated in Step 183, the Authorization Proxy Unit 189 utilizes the user-related OC and the data-related OC, and further utilizes the relevant rules from the pre-defined organizational Selective LLM Authorization Policy 157, to generate—using the Assistive LLM 188—one or more Prompt Modifiers or Prompt Add-Ons, one or more filtering-out prompt modifiers or add-ons (e.g., that would specifically notify the LLM which data-items are not authorized to be included in the LLM-based output, or which data-items must be removed or masked or omitted or excluded from the LLM-based output), one or more filtering-in prompt modifiers or add-ons (e.g., that would specifically notify the LLM which data-items are authorized to be included in the LLM-based output), or other grounding rules or grounding prompt add-ons.

For example, the Authorization Proxy Unit 189 may feed into the Assistive LLM 188 the following items: (a) the original query/prompt from the querying user, including its content and its meta-data; (b) the user-related OC and the data-related OC; (c) the entirety of the pre-defined organizational Selective LLM Authorization Policy 157, or (in some implementations) one or more rules that the Authorization Proxy Unit 189 has selectively picked from that pre-defined organizational Selective LLM Authorization Policy 157; (d) a pre-defined prompt that is directed to the Assistive LLM 188, which commands it to generate an Adapted Query (or a constrained query, or a grounded query, or a modified query, or a replacement query) that is intended to be fed into the LLM-Enabled Application 156 and is expected or predicted (by the Assistive LLM 188) to yield output that would comply with the Rules that were provided to the Assistive LLM 188.

In accordance with some embodiments, if the pre-defined organizational Selective LLM Authorization Policy 157 indicates that the action that should be taken, for this particular user OC and data OC, is an action of “adapt”, then: the Authorization Proxy Unit 189—in conjunction with the Assistive LLM 188—generates the relevant filtering-out/filtering-in/grounding/constraining prompt modifiers or prompt add-ons; and adds them to the original query/prompt; and optionally adds the user-related and data-related OC; and sends (Step 184) the modified/adapted prompt to the LLM-Enabled Application 156, which in turn performs the LLM-based analysis (Step 185) by utilizing the adapted queries to query the Data Sources 151, and returns LLM-based output to the end-user device 199 of the querying user (Step 186A or 186B). In a first variant of this implementation, the LLM-based output is sent back from the LLM-Enabled Application 156 to the querying user (Step 186A), without additional filtering or screening or adaptation or modification; since the LLM-Enabled Application 156 has already operated based on an adapted query. In a second variant of this implementation, the LLM-based output is sent from the LLM-Enabled Application 156 to the Authorization Proxy Unit 189, which provides that LLM-generated output to the Assistive LLM 188 which, in turn, performs another iteration of data adaptation or sanitizing by checking whether or not the LLM-based output complies with the relevant rules in the pre-defined organizational Selective LLM Authorization Policy 157, and to mask or delete or conceal or remove data-portions that do not comply with those rules; and only then, the Authorization Proxy Unit 189 sends (Step 186B) to the querying user the LLM-based output that was possibly further modified/adapted by the Assistive LLM 188 based on those rules.

In contrast, if the pre-defined organizational Selective LLM Authorization Policy 157 indicates that the action that should be taken, for this particular user OC and data OC, is an action of “block”, then: the Authorization Proxy Unit 189 (optionally utilizing compliance insights generated by the Assistive LLM 188) blocks the original query/prompt of the querying user, and does not send it (does not forward it, does not relay it) to the LLM-Enabled Application 156; and optionally, the Authorization Proxy Unit 189 sends a response to the querying user indicating that this query was blocked due to an organizational policy.

In some embodiments, optionally, the output of the LLM-Enabled Application 156 is not transferred directly or immediately to the querying user; but rather, the LLM output is checked against the relevant rules from the pre-defined organizational Selective LLM Authorization Policy 157, in view of the relevant user-related OC and data-related OC. Such additional compliance checks may be performed by the Assistive LLM 188, to further ensure that the LLM output (from the LLM-Enabled Application 156) indeed complies with the relevant rules and does not provide to the querying user any sensitive information that the pre-defined organizational Selective LLM Authorization Policy 157 does not allow to provide. In some embodiments, the LLM output is thus further adapted/modified/filtered/sanitized prior to its actual deliver to the querying user, based on those rules and in view of the user-related OC and data-related OC.

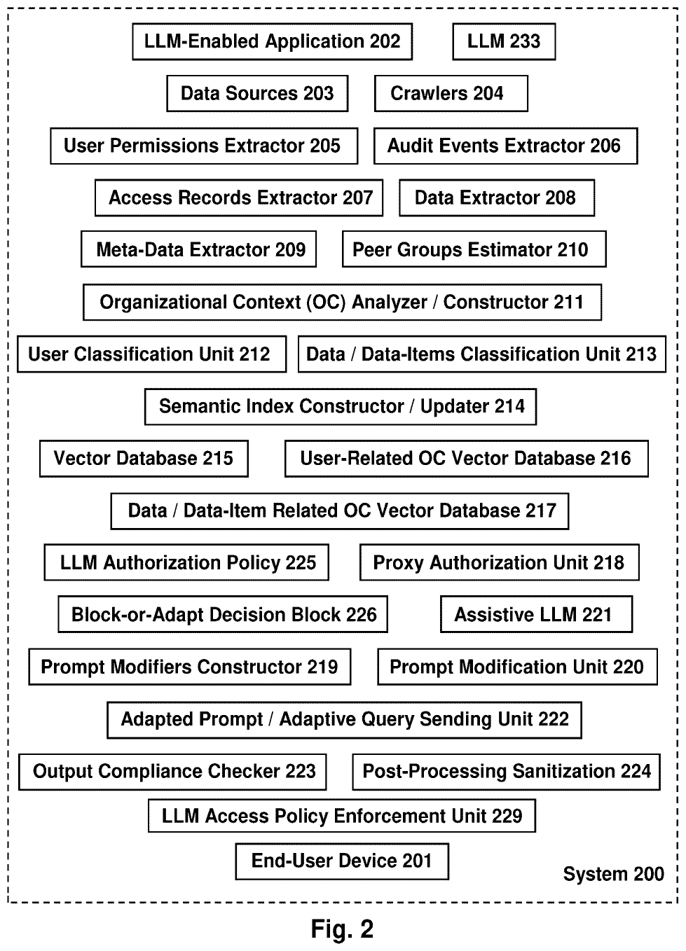

Reference is made to FIG. 2, which is a schematic block-diagram illustration of a system 200, in accordance with some demonstrative embodiments. For example, system 200 and/or its components may be an implementation of system 160 or system 170 or system 180 discussed above.

As illustrated, a querying user may utilize an End-User Device 201 to submit an original query/original prompt, intended to be processed by an LLM-Enabled Application 202 (that is associated with an LLM 233) based on one or more organizational Data Sources 203. The Data Sources 203 may include a variety of information repositories and/or directories and/or silos; files, folders, documents, electronic messages, databases, CRM systems, SCM systems, ERP systems, Active Directory (AD) information, Azure Active Directory (AAD) information, organizational chart, organizational directory of team-members, email mailboxes and email messages, instant messaging data, group messaging data, and other types of data.

One or more Crawlers 204 are configured to crawl the Data Sources 203, and to perform data extraction to enable data indexing. For example, a User Permissions Extractor 205 may extract user permissions data from the Data Sources; an Audit Events Extractor 206 may extract audit events; an Access Records Extractor 207 may extract data indicating which user accessed (read, wrote, modified, deleted, created, copied) which file/data-item and other relevant meta-data (at what time and date, from which device, locally or remotely); a Data Extractor 208 may extract other data or content from the Data Sources 203; and a Meta-Data Extractor 209 may extract meta-data related to particular data-items (e.g., who created/modified, when was the creation/modification). Optionally, a Peer Groups Estimator 210 may analyze the extracted data and may estimate/detect/construct Peer Groups based on data and/or meta-data; for example, estimating that User Adam and User Bob are in the same peer group, since they email to each other several times per day and since the organizational chart indicates that Adam reports directly to Bob.

An Organizational Context (OC) Analyzer/Constructor 211 is configured to construct, and to periodically update, Organizational Context (OC) from the extracted data and meta-data. For example, a User Classification Unit 212 may classify users based on roles/positions, membership in peer groups or in a department, membership in a project, or other criteria; and similarly, a Data/Data-Items Classification Unit 213 may classify data-items/documents/files based on relevance to a particular department/project/peer group/user, or based on belonging to or being created/accessed/modified by a particular department/project/peer group/user. A Semantic Index Constructor/Updater 214 is configured to construct, and periodically update, a Semantic Index or several such semantic indices (e.g., for user-related OC, and for data-item related OC); optionally utilizing (or implemented as) a Vector Database 215, or a plurality of such Vector Databases such as a User-Related OC Vector Database 216 and a Data/Data-Item Related OC Vector Database 217.

In accordance with some embodiments, a pre-defined organizational Selective LLM Authorization Policy 225 may be prepared or hard-coded, or may be updated periodically/manually based on organizational policies indicating which user (or which type-of-user) is authorized (or, is not authorized) to access which particular data-items or types of data-items.

In some embodiments, the original query/prompt from the querying user is firstly intercepted or analyzed by a Proxy Authorization Unit 218, which may be connected prior to or before the LLM-Enabled Application, or may be implemented as a plug-in or extension or add-on module to the LLM-Enabled Application.

The Proxy Authorization Unit 218 (or plug-in) obtains or fetches the relevant user-related OC and the data-item related OC, and it also obtains or fetches the relevant rules from the Selective LLM Authorization Policy 225. Based on the obtained information, a Prompt Modifiers Constructor Unit 219 construct prompt add-ons or prompt modifiers or prompt-constraining strings or prompt-constraining instructions or grounding instructions or grounding add-ons, that would accompany the original query and would constrain/ground/limit its scope to ensure that the LLM-based output would comply with the relevant rules in the Selective LLM Authorization Policy 225 as applicable based on the user-related OC and the data-item related OC. It is noted that in some embodiments, a Block-or-Adapt Decision Block 226 or similar unit or module may be used, configured to reach a decision, with regard to a particular original query, either to block it entirely from being processed by the LLM, or to allow it to be adapted (modified) and then processed in its adapted (modified) version.

In some embodiments, the prompt modifiers or query add-ons are added to the original query/prompt by a Prompt Modification Unit 220. In some embodiments, additional or alternatively, an Assistive LLM 221 can be used at this stage for constructing the adapted query or the adapted prompt; for example, the Assistive LLM 221 may receive as input (a) the original query, (b) the user-related OC, (c) the data-item related OC, (d) the Selective LLM Authorization Policy 225 or relevant/extracted portions or rules therefrom; and the Assistive LLM 221 may generated the Adapted/Modified prompt.

Then, the modified or adapted prompt is sent by an Adapted Prompt (or Adapted Query) Sending Unit 222 to the LLM-based Application 202; which in turn performs LLM-based analysis of the adapted prompt by using data-items and information from the Data Sources 203, generating a first version of LLM-generated output.

In some embodiments, that first version of the LLM-generated output can be regarded as sufficiently compliant with organizational policies, since it was generated based on an Adapted Prompt and not based on the original query of the querying user; and in such implementations, the first version of the LLM-generated output is transferred/conveyed/sent back to the querying user, without performing another sanitizing/checking iteration.

In some other embodiments, that first version of the LLM-generated output is regarded as not necessarily compliant with organizational policies, and an iteration of sanitizing/checking is performed prior to conveying the LLM-generated output to the querying user. For example, the first version of the LLM-generated output is sent to an Output Compliance Checker Unit 223 and/or by a Post-Processing Sanitization Unit 224, which can optionally utilize the Assistive LLM 221, and which is configured to review or analyze the first version of the LLM-generated output and to check its compliance with the relevant rules of the Selective LLM Authorization Policy 225. The Output Compliance Checker Unit 223 may determine that the first version of the LLM-generated output, or portions thereof, should be blocked/deleted/omitted/excluded/redacted/masked, and an Output Modification Unit 225 or the Post-Processing Sanitization Unit 224 performs such deletions or masking of such particular data-portions (e.g., names, dates, prices), or performs other modifications/adaptation to the first version of the LLM-generated output, thereby generating a second (modified, adapted) version of the LLM-generated output, which is then conveyed/sent to the querying user. In some embodiments, optionally, post-processing sanitization operations, or other operations that adapt or mask or delete or exclude one or more strings or portions of the original LLM-generated output, may be performed with the assistance of the Assistive LLM 221 (or, by using another LLM that is fine-tuned or re-trained for data sanitization).

For demonstrative purposes, some portions of the discussion above and/or herein may relate to the utilization of the LLM (or other Generative-AI tool or AI tool) by users of a business organization; however, these are only non-limiting examples, and some embodiments may be configured to similarly operate in other scenarios or use-cases, that do not necessarily involve business organizations or any type of organization, yet still enforce a particular Access Policy that was pre-defined by one or more administrator/supervisor entities or users.

In a first example, parents or guardians in private residence (e.g., apartment, house, home) may have a wireless home network, and may utilize an end-user device to configure a home server or router or wireless Access Point (AP) or firewall unit, that would enforce a parents-defined or guardians-defined LLM access policy or LLM constraints policy. For example, the parent/guardian may define an LLM access policy or an LLM authorization policy or an LLM constraints policy, that would block or disallow user inquiries/queries/prompts that are related to particular topics (e.g., sex, drugs, alcohol, tobacco) and/or that include particular words or keywords or strings (e.g., “gun” or “explosives” or “pornographic” or “cigarettes”), and/or that are expected to yield LLM-generated results that may include data or content that pertains to such topics and/or keywords. The policy may be enforced by an LLM Access Policy Enforcement Unit 229, which may be part of the home network, and/or may be configured via an application or “app” from a smartphone or laptop of the parent/guardian, or that may be part of a component (e.g., home router, set-top box, wireless AP, firewall unit) that is provided by an Internet Service Provider (ISP), or may otherwise be implemented as part of the system or as a network element. It is noted that in some embodiments, prompts or queries by an end-user do not necessarily cause a complete blocking or an “access denied” response to the user; but rather, in accordance with some embodiments, cause a dynamic modification/redaction/replacement of one or more content-portions or data-portions from the LLM-generated output, in order to comply with such LLM access policy or an LLM authorization policy or an LLM constraints policy.

In another demonstrative example, a school or an educational/academic institution, may similarly create an LLM access policy or an LLM authorization policy or an LLM constraints policy, that would similarly block or disallow user queries of students or teachers or other members of such institution; and would similarly cause a dynamic modification/redaction/replacement of one or more content-portions or data-portions from the LLM-generated output, in order to comply with such LLM access policy or an LLM authorization policy or an LLM constraints policy.

In another demonstrative example, a religious institution (e.g., a church, a synagogue, a religious facility) may similarly create an LLM access policy or an LLM authorization policy or an LLM constraints policy, that would similarly block or disallow user queries of guests/visitors/members of such institution; and would similarly cause a dynamic modification/redaction/replacement of one or more content-portions or data-portions from the LLM-generated output, in order to comply with such LLM access policy or an LLM authorization policy or an LLM constraints policy.

In another demonstrative example, the system may further take into account user-specific data or characteristics, such as age or role or other characteristics, in order to apply and/or enforce the LLM access policy. For example, a school may define an LLM access policy that would block or modify queries about “alcohol” or “drugs” if they are submitted by minors/students, but that would allow and/or would differently modify (e.g., would less modify) queries about those topics if they are submitted by a teacher/an adult. The system may know which type of user is submitting the query, for example, as the user may be required to log-in to the school's system or network in order to submit queries, and the user's profile may indicate his age and/or his role (student/teacher). In another example, data about the age or role or other characteristics of the Querying User may be obtained from a social media profile of that user, if the Querying User is logged-in to the system via his social media credentials or authentication token. In another example, data about the age or role or other characteristics of the Querying User may be obtained from an email account profile or a user account profile of that user, if the Querying User is logged-in to the system via such user account (e.g., via his Google account, via his Outlook account). It is noted that the socio-demographic data about the Querying User is used, in some embodiments, not only/not necessarily in order to block or disallow an LLM query from being executed; but rather, in order to dynamically modify/adapt/redact/replace one or more content-portions or data-items that are part of the LLM-generated outputs, based on the LLM access policy or an LLM authorization policy or an LLM constraints policy and based on the specific characteristics of the Querying User as obtained from his user profile or from other available sources.

Some embodiments may improve the utilization of Large Language Models (LLMs) within or by organizations, by tailoring the LLM outputs to specific user roles and access levels.

The system ensures that the data that is retrieved and/or processed and/or presented by the LLM to a querying user, is relevant and permissible based on the user's role and based on Organizational Context and rules derived from an organizational policy, and ensures data security and compliance with organizational policies with regard to confidential or sensitive data or with regard to which user may or may not access which data-item.

For example, the system is configured to dynamically tailor responses from the LLM based on the user's role and the relevant OC. For instance, a CEO querying about project milestones would receive comprehensive details, including sensitive financial information; whereas a junior salesperson may only receive data pertinent to sales, excluding financial details. The system utilizes a pre-defined Selective LLM Authorization Policy, which dictates the type of information each user can access. This policy leverages organizational context (OC), including user roles, departments, and projects, to filter the data dynamically.

The system may continuously or periodically index organizational data sources, which include data lakes, databases, CRM systems, ERP systems, SCM systems, AD/AAD, and other information sources. The indexing process extracts information about user roles, permissions, and past interactions, forming a detailed OC that is stored in a semantic index, such as a vector database.

Queries from users are adapted or modified, based on the user's OC and the Selective LLM Authorization Policy, before being processed by the LLM. This adaptation can involve modifying the query to include or exclude specific data types, or adding grounding prompts to ensure compliance with the policy, or blocking information or data-items from being included in the LLM analysis, or blocking or masking or deleting particular data-items or types of data-items (e.g., names, dates, prices).

For example, crawlers continuously or periodically scan the organizational data sources to extract relevant data, permissions, and audit events, which are then analyzed and indexed. An Authorization Proxy Unit or an Authorization Plug-in intercepts the user's query before it reaches the LLM or before it is executed/performed by the LLM. This component adapts or modifies the query based on the relevant OC and the Selective LLM Authorization Policy, ensuring that the adapted query only requests and later provides permissible data for this specific querying user.

Optionally, in some configurations, an Assistive LLM helps in constructing adapted queries and/or in verifying the compliance of the primary LLM's output. The Assistive LLM can be a specialized LLM for generating constrained prompts and/or for ensuring compliance with the authorization policy.

The system performs a pre-defined procedure or method for Query Processing and Output Adaptation. For example: (a) Initial Query Handling: When a user submits a query, the system first determines the user's role and relevant OC. It then adapts the query according to the Selective LLM Authorization Policy. (b) LLM Processing: The adapted query is processed by the LLM, which retrieves and analyzes the relevant data. The LLM's output is initially generated based on the adapted query. (c) Compliance Check and Final Output: The initial LLM output undergoes a compliance check against the authorization policy. If necessary, the system further modifies or adapts the output to mask or remove unauthorized information before delivering it to the user.

The following are some non-limiting example of use-cases or scenarios, demonstrating some of the functionality of the system. In a first scenario of Project Queries, a CEO querying about a project would get full details, including financials and timelines; whereas a junior member of the Sales department querying the same project would receive only sales-related data, excluding any financial information. In a second scenario of Confidential Information Access, user queries involving sensitive information, like employee salaries or API keys, are strictly controlled; for instance, a DevOps team member may be authorized to access API keys, but a junior developer would not; and similarly, a senior manager in the HR department may access employee salaries, whereas a junior graphic designer may not.

The system may provide a variety of benefits and advantages, such as the following examples. (a) Enhanced Data Security: By tailoring data access based on user roles, the system minimizes the risk of unauthorized information access and data leaks. (b) Efficient Data Utilization: Users receive relevant data tailored to their roles, enhancing their efficiency and decision-making capabilities without overwhelming them with unnecessary information. (c) Compliance and Policy Enforcement: The system ensures that organizational policies (which may often reflect legal constraints) are adhered to, providing a secure and compliant data querying environment. (d) Scalable and Adaptable: The architecture is flexible and can adapt to different organizational structures and policies, making it suitable for various industries and applications.

Some embodiments thus provide a system for managing data access and utilization within organizations using LLMs. By dynamically tailoring LLM outputs based on user roles and organizational context, the system enhances data security, efficiency, and compliance, providing a robust solution for modern data-driven enterprises.

Some embodiments may provide some, or all, of the following benefits or advantages. (a) Role-Based Query Response: The system tailors LLM outputs to user roles, ensuring that each team member receives relevant and appropriate data based on their position and responsibilities, enhancing data security and relevance. (b) Selective LLM Authorization Policy: The system uses a pre-defined policy to dynamically filter data, allowing or restricting access based on organizational context, user roles, and specific data classifications, ensuring compliance with security protocols. (c) Organizational Context Indexing: The system continuously or periodically indexes organizational data sources, including data lakes and CRM/SCM/ERP systems, extracting and updating information about user roles, permissions, and interactions to maintain an accurate context. (d) Adaptive Query Processing: the system adapts and modifies user queries based on organizational context and authorization policies before LLM processing, ensuring that only permissible data is requested and retrieved. (c) Assistive LLM for Query Adaptation: optionally, the system utilizes a specialized Assistive LLM to construct adapted queries and/or to verify outputs of the LLM-Enabled Application, to improve and double-check the compliance with organizational policies by generating constrained prompts. (f) Authorization Proxy Unit: this component intercepts and adapts user queries before they reach the LLM or before they are processed by the LLM, using organizational context and authorization policies to modify the queries and ensure secure data access. (g) Compliance Verification of Outputs: the system may conduct a compliance check on the LLM-generated outputs against authorization policies, modifying or sanitizing data to prevent unauthorized information from being delivered to users. (h) Dynamic Data Filtering: the system implements real-time data filtering based on user roles and organizational context, dynamically adjusting the information presented to different users to enhance security and relevance. (i) Multi-Source Data Integration: the system enables an organization to integrates data from various sources, including local, remote, cloud-based, and on-premises repositories, forming a comprehensive data lake that can be securely and safely queried by the LLM while also observing rules that dictate access control of particular users to particular data-items or documents or information. (j) Peer Group Estimation: optionally, the system analyzes user interactions and data access patterns to estimate or determine peer groups, enhancing the accuracy of organizational context and improving query adaptation based on user behavior. (k) Real-Time Organizational Context Updates: the system periodically (e.g., daily, weekly) updates the organizational context, reflecting changes in user roles, permissions, project membership, department membership, and data access events, ensuring that query responses remain accurate and relevant over time. (l) Grounding and Prompt Modification Techniques: the system creates and utilizes grounding rules and prompt modifiers to adapt queries, ensuring that the LLM operates within the constraints of the authorization policy, thereby preventing data leakage or access of users to data that they are not permitted to view. (m) Dual-Stage Data Protection: in some embodiments, the system provides dual-stage protection by adapting queries before LLM processing and later sanitizing outputs after LLM processing, ensuring comprehensive security and improved compliance. (n) Flexible Implementation Architectures: the system may support various implementation architectures, including proxy units, plug-ins, and assistive LLMs, allowing organizations to choose the most suitable configuration for their specific needs and security requirements.

Some embodiments may provide some of the following surprising or non-obvious or counter-intuitive features. (a) Differential LLM Output for Same Query, based on OC: The same query can yield different outputs depending on the user's role and the relevant OC, ensuring that sensitive information is selectively provided and enhancing data security as well as response relevance. (b) Context-Aware Crawlers, that index data and enable the system to understand and construct organizational context, dynamically adapting to changes in user roles and permissions for accurate and secure query responses. (c) Semantic Indexing of Organizational Context: the system stores and updates organizational context in a semantic index or vector database, allowing for precise adaptation of queries and responses based on real-time user and data classifications. (d) Assistive LLM for Query Adaptation: optionally, the system uses a secondary LLM to assist in modifying queries and/or in verifying outputs, ensuring improved compliance with authorization policies while leveraging the primary LLM for data analysis. (c) Dual-Stage Query and Output Adaptation: the system adapts queries before LLM processing, and optionally also adapts LLM-generated output, thereby providing a two-tiered security approach that ensures sensitive data is protected throughout the query lifecycle. (f) Grounding Prompts and Query Modifiers from User Data, Metadata, and OC: the system automatically generates grounding prompts or query modifiers based on user data and metadata and organizational context, dynamically adapting queries to align with user-specific authorization policies. (g) Adaptive Compliance Checks: optionally, post-processing compliance checks adaptively sanitize LLM outputs, removing unauthorized information based on dynamic rules and real-time organizational context. (h) Role-Specific Query Modifications: the system modifies queries to include or exclude specific data types based on user roles, ensuring that users receive relevant information without accessing sensitive data. (i) Multi-Modal Data Integration: optionally, the system combines data from diverse sources, and enables comprehensive and context-aware querying by the LLM or by other AI-based tools or multiple-modalities models.

Some embodiments may include, or may utilizes, some or more of the following components. (A) User Interface Module, which allows users to input queries and view responses; it provides a user-friendly interface for submitting natural language queries and receiving tailored outputs based on user roles and organizational context. (B) Authorization Proxy Unit, which intercepts and adapts user queries before reaching the LLM; it ensures compliance with organizational policies by modifying or blocking queries based on user roles and authorization rules. (C) Large Language Model (LLM): The primary AI component that processes adapted queries and generates responses, taking into account data from organizational data sources; typically trained on vast datasets to understand and respond to natural language queries accurately. (D) Assistive LLM, an optional component of a secondary AI model that assists in adapting queries and/or verifying compliance of LLM-generated outputs; it ensures that the primary LLM's responses would comply with organizational policies and access control protocols. (E) Selective LLM Authorization Policy Database, which stores pre-defined rules and policies dictating data access permissions based on user roles, departments, and other organizational contexts. It dynamically guides query adaptations. (F) Organizational Context Indexer, which continuously or periodically scans and indexes organizational data sources, extracting and updating information about user roles, permissions, and data interactions to maintain an accurate organizational context. (G) Organizational Data Lake, which is a unified or centralized or distributes repository, or a collection of data silos and databases, for all organizational data, including documents, emails, databases, CRM information, ERP information, SCM information, or the like; which serves as the primary data source for the LLM for responding to user queries. (H) Crawlers, or other automated tools that scan and extract data from various sources within the organization; and continuously update organizational context index with fresh information. (I) User Metadata Extractor, which collects and updates information about users, such as roles, permissions, and interactions. This data is crucial for adapting queries and responses based on the user's context. (J) Semantic Index/Vector Database, which stores and updates semantic representations of organizational context, enabling precise adaptation of queries and responses based on real-time user and data classifications. (K) Query Adaptation Module, which modifies user queries based on the organizational context and authorization policies; it ensures that only permissible data is requested from and retrieved by the LLM. (L) Prompt Modifiers Constructor, which generates prompt add-ons, constraints, and grounding rules to be included in adapted queries; it ensures that adapted queries comply with organizational policies before reaching the LLM or before being processed therein. (M) Output Compliance Checker, which analyzes the LLM-generated outputs to ensure they comply with authorization policies; it modifies or sanitizes the data to prevent unauthorized information from being delivered to users. (N) Data Classification Unit, which classifies data items based on relevance to departments, projects, and/or user roles; this classification helps in filtering and adapting query responses based on user-related organizational context. (O) Audit Events Extractor, which extracts and logs access events, such as which users accessed which data items; this information helps in detecting and tracking data access patterns, to construct or improve user-related organizational context. (P) User Classification Unit, which classifies users based on roles, departments, teams projects, peer groups, and/or other criteria; this classification is used to tailor query responses and enforce data access rules. (Q) Peer Groups Estimator, which analyzes user interactions and access patterns to estimate or define peer groups, enhancing the accuracy of organizational context and improving query adaptation based on user behavior.

Some embodiments may provide a system that generates the following innovative outputs or deliverables. (a) Role-Specific Project Summaries: the system can generate tailored summaries of project milestones and progress reports based on the querying user's role, providing high-level details and/or financial details to executives, and more focused information to junior/sales team members relevant to their departmental needs. (b) Customized Financial Reports: the system can provides financial data and/or analytics tailored to specific user roles, ensuring that sensitive information like budget details and profit margins are visible only to authorized personnel such as CFOs and finance managers, and not to junior developers. (c) Adaptive Sales Insights: the system can delivers sales performance metrics and customer insights that are customized for the sales team, intentionally excluding sensitive financial details, while also highlighting sales trends, targets, and achievements relevant to their department. (d) Department-Specific Operational Reports: the system can produce operational reports with information filtered based on the querying user's department and based on the relevant OC, providing specifically-relevant operational metrics while excluding unrelated data to ensure efficient and effective use of the information. (c) Tailored Training Material: the system can, for example, generates customized training content and training resources for different roles within the organization, ensuring that employees receive relevant and role-specific training materials that enhance their skills and knowledge; such that a junior developer and a senior salesperson in the same organization would receive different and useful answer to the same query of “Please suggest three ways in which I can improve my performance in the organization”. (f) Adaptive HR Reports: the system can create HR reports that include detailed personnel data for HR managers, while providing summarized data for other roles, ensuring privacy and compliance with organizational policies on employee information. (g) Project Progress Update: the system can tailor progress updates about a particular project, providing comprehensive details including timelines and budgets to the relevant/senior project managers, while providing high-level overviews (without all the sensitive information) to other stakeholders and department heads, and while providing minimal data or no data to junior team-members who are not directly involved with the queried project. (h) Customized Client Lists: the system can generate lists of clients or customers based on specific queries, excluding sensitive information such as financial transactions unless the user is authorized to view such data, ensuring compliance with data privacy regulations; and enabling the system to generate different responses to the same (or similar) user request to generate a customer list, based on organizational context of the querying user. (i) Selective API Key/Password Reports: the system can provide reports on API keys and access credentials to relevant/senior DevOps team members, ensuring that such sensitive information is not accessible to unauthorized users, thereby enhancing and respecting security; while also blocking or denying requests from team-members that are not permitted (by the organizational policy) to have access to such keys or passwords. (j) Filtered Supplier Data: the system can provide supplier information with financial data included for procurement or finance departments, while providing general supplier lists (e.g., without contract terms or prices) to other relevant team members, and/or while providing no information or minimal information to team-members whose role does not require or does not involve any interaction with suppliers or vendors.

Some embodiments may solve or cure or mitigate some, or all, of the following problems or disadvantages of conventional systems. (a) Unauthorized Data Access: the system can prevent unauthorized access to sensitive information, by tailoring LLM outputs based on user roles and OC, ensuring that only authorized personnel can view confidential or sensitive data, thereby enhancing data security and preventing data leakage within the organization to unauthorized personnel. (b) Data Overload: the system can mitigate data overload of users, by filtering and customizing query responses based on user roles, providing relevant information without overwhelming users with unnecessary data; for example, a junior salesperson that inquires about products for sale, would receive LLM-based responses about the products and their features and prices, without data about the cost to produce or the margin of profit or other data that is not directly relevant to his role or position or tasks. (c) Compliance Violations: the system can ensure compliance with legal and organizational policies, by dynamically adapting query responses to exclude information that users are not authorized to access, preventing accidental or intentional policy violations by team-members. (d) Inefficient Data Retrieval: the system can enhance efficiency in data retrieval, by providing tailored responses to users based on their roles and the relevant OC, ensuring that users receive relevant and actionable information quickly, without needing to sift through a large volume of irrelevant data that a conventional LLM may generate without query adaptation. (c) Lack of Contextual Data Analysis: some systems can address the problem of lack of contextual analysis, by incorporating organizational context into data queries, ensuring that LLM-generated responses are relevant and tailored to specific user needs and roles. (f) Inconsistent Data Handling: the system can help in standardizing data handling across the organization, by implementing a consistent authorization policy, ensuring that data access and retrieval processes are uniform and compliant. (g) Data Privacy Risks: the system can mitigate data privacy risks by adapting query responses to exclude personal or sensitive information for unauthorized users, protecting employee privacy and customer privacy. (h) Information Leakage: the system can prevent sensitive/confidential information leakage, by enforcing strict authorization policies, ensuring that sensitive or confidential information is not inadvertently shared with unauthorized personnel, who cannot/should not access such information or documents or files directly, and now cannot access or view such information indirectly via LLM queries towards organizational data sources. (i) Manual Query Adaptation: the system eliminates the need for manual query adaptation, by automating the process, reducing human error, and ensuring that all queries are compliant with organizational policies; for example, obviating the need for a junior salesperson to add manually, to his own query, “Please provide me with a list of customers from the last year, but note that I am a junior salesperson and I am not authorized to view profit of margin data or product cost data”. (j) Ineffective Training: the system can improve the effectiveness of training programs or the effectiveness of responses for performance advice, by generating tailored training materials or advice to users based on user roles and based on the relevant OC, ensuring that employees receive relevant and role-specific information; for example, providing differential LLM-generated responses to the same query of “Please suggest three ways in which I can improve my performance in the organization” if the query is posed by different users (e.g., by a junior developer, or by a senior marketing manager). (k) Operational Inefficiency: the system can enhances operational efficiency by delivering department-specific and even user-specific reports and insights, that takes into account the relevant OC, thereby enabling teams and users to focus on relevant data and make informed decisions without unnecessary delays.

Some embodiments may provide a system for generating role-based query responses from a Large Language Model (LLM), comprising: a user interface for receiving queries; an authorization module for determining user roles; a query adaptation module for modifying queries based on user roles; and an LLM for generating tailored responses based on the adapted queries.

Some embodiments may provide a system for controlling data access in response to user queries, comprising: a data repository containing organizational data; an authorization policy database storing access rules; an authorization proxy unit for intercepting and adapting user queries based on the authorization rules; and an LLM for generating query responses with selectively filtered data based on automatically adapted or automatically modified queries.

Some embodiments provide a sub-system for indexing organizational context, comprising: data crawlers for scanning organizational data sources; an organizational context analyzer for extracting and classifying data; a semantic index for storing the classified data; and a query adaptation module for utilizing the organizational context to modify user queries. The system is configured for adaptively processing user queries, by including: a user interface for receiving queries; an authorization module for determining user roles and permissions; a query adaptation module for modifying queries based on user context; and an LLM for generating responses to the adapted queries.

Some embodiments provide a system for automatic and LLM-based assistance/handling of query adaptation, comprising: a primary LLM for generating responses; an assistive LLM for constructing adapted queries that conform to organizational policies in view of organizational context; an authorization module for enforcing access rules; and a query adaptation module for modifying user queries based on inputs from the assistive LLM and the authorization module.

Some embodiments provide a system for protecting data in dual stages, comprising: a query interception module for modifying queries before LLM processing; an LLM for generating initial query responses; an output compliance checker for verifying responses against authorization policies; and a data sanitizer for modifying responses to ensure compliance.

Some embodiments provide a system for dynamically filtering data in response to user queries, comprising: a data repository containing organizational data; an authorization policy database; a query adaptation module for filtering queries based on user roles; and an LLM for generating responses with dynamically filtered data.

Some embodiments provide a system for verifying compliance of LLM outputs, comprising: a user interface for receiving queries; an LLM for generating initial query responses; an output compliance checker for verifying responses against organizational policies; and a data sanitizer for modifying responses to ensure compliance before delivery to users.

Some embodiments provide a system for classifying data based on user roles, comprising: data crawlers for scanning organizational data sources; a data classification unit for categorizing data based on relevance to user roles; a semantic index for storing classified data; and an LLM for generating query responses tailored to the classified data based on adapted queries.

Some embodiments provide a system for role-based query response with organizational context indexing, or a system for generating role-based query responses from an LLM. The system may include: a user interface for receiving queries; an authorization module for determining user roles and permissions; a data repository containing organizational data; data crawlers for scanning and extracting data from the organizational data sources; an organizational context analyzer for classifying and indexing the extracted data into a semantic index; a query adaptation module for modifying queries based on the user roles and the indexed organizational context; and an LLM for generating tailored responses based on the adapted queries.

In some embodiments, the user interface includes natural language processing capabilities for interpreting and processing user queries. In some embodiments, the data crawlers operate continuously to keep the organizational context index up-to-date. In some embodiments, optionally, the organizational context analyzer may use Machine Learning (ML) algorithms to classify and index the data. In some embodiments, the semantic index is implemented using a vector database for efficient retrieval of organizational context information. In some embodiments, the query adaptation module incorporates user-specific constraints and organizational policies into the adapted queries. In some embodiments, the data crawlers may include a peer group estimator for analyzing user interactions and grouping similar users. In some embodiments, the organizational context analyzer also tracks historical data access patterns to refine user role definitions. In some embodiments, the semantic index supports semantic searches, enabling context-aware query adaptation. In some embodiments, the query adaptation module uses natural language generation techniques to refine the adapted queries. In some embodiments, the LLM includes a compliance module implemented as an Authorization Plug-in, that ensures that LLM-generated responses adhere to organizational policies and rules. In some embodiments, optionally, the system may provide interactive feedback to users about the scope and limitations of their queries based on their roles and based on the relevant OC. In some embodiments, the authorization module may optionally integrate further with external identity management systems, to synchronize user roles and permissions and/or to further obtain additional data regarding the querying user and his role. In some embodiments, the data repository or the organizational data sources may include both structured and unstructured data sources. In some embodiments, the query adaptation module can filter out sensitive information based on predefined confidentiality levels and/or based on rules reflecting access control. In some embodiments, the LLM is capable of performing iterative learning based on user feedback to improve response accuracy. In some embodiments, the authorization module includes (or is connected to) an audit/logging unit, to track and review query adaptations and data access events. In some embodiments, optionally, the organizational context analyzer uses topic modeling to categorize data items into relevant thematic groups.

Some embodiments may optionally implement Advanced User Behavior Analytics, to track and analyze user interactions with the system, providing insights into usage patterns, improving the accuracy of role-based adaptations, and identifying opportunities for personalized training and support. For example, the system may observe that junior salespeople repeatedly query about the profit-of-margin or a particular line of products, and may deduce that this data-item or data-type (profit of margin) may be relevant to this organizational role (salesperson), possibly as a relevant consideration in considering whether a discount can be given to a customer; and the system can automatically aggregate such attempts, deduce that the data-item or data-type is relevant, and recommend/suggest to a system administrator to authorize the inclusion of such data in response to queries of this type.

Some embodiments provide a computerized method comprising: (a) receiving an original prompt that a querying user sends to a Large Language Model (LLM) that is operably connected to organizational data sources of an organization; (b) instead of executing said original prompt by the LLM, performing: (b1) obtaining user-related organizational context that pertains to characteristics of the querying user; (b2) obtaining data-related organizational context that pertains to data from which said LLM is expected to obtain information for responding to the original query; (b3) obtaining pre-defined organizational policy rules, that indicate which type of users are authorized to access which type of organizational data; (b4) based on (i) the user-related organizational context, and (ii) the data-related organizational context, and (iii) the pre-defined organizational policy rules, modifying the original prompt into an adapted prompt; (c) sending the adapted prompt, and not the original prompt, to the LLM for processing, and obtaining LLM-generated output from said LLM in response to said adapted prompt; and providing that LLM-generated output to the querying user.

In some embodiments, step (a) of receiving the original prompt comprises: intercepting the original prompt on a communication path from an electronic device of the querying user to said LLM; wherein step (b4) of modifying the original prompt comprises: modifying the original prompt on said communication path, wherein only the adapted prompt and not the original prompt is transferred to said LLM for processing.

In some embodiments, step (a) of receiving the original prompt comprises: receiving the original prompt at said LLM; and transferring the original prompt, without processing the original prompt, to an LLM extension module that performs prompt adaptation operations of steps (b1) through (b4) and then transfers the adapted prompt to said LLM for processing.

In some embodiments, step (b4) of modifying the original prompt comprises: constructing the adapted prompt by an Assistive LLM, that is pre-configured or pre-trained or fine-tuned to specialize in prompt engineering and LLM grounding; wherein the Assistive LLM receives as input: (i) the original prompt, and (ii) the user-related organizational context, and (iii) the data-related organizational context, and (iv) the pre-defined organizational policy rules.

In some embodiments, obtaining the user-related organizational context comprises: analyzing organizational data sources, and determining from event audit logs whether the querying user is authorized or unauthorized to access a particular type of data.

In some embodiments, obtaining the user-related organizational context comprises: analyzing organizational data sources, and estimating to which peer groups said querying user belongs; and based on belonging or non-belonging of the querying user to one or more particular peer groups, determining whether the querying user is authorized or unauthorized to access a particular type of data.

In some embodiments, obtaining the user-related organizational context comprises: analyzing organizational data sources, and estimating whether or not information that is expected to be returned by said LLM in response to the original query, is information that an organizational position of the querying user typically accesses and uses; and if not, then adapting the original query to cause exclusion of said information from the LLM-generated output.

In some embodiments, the computerized method further comprises: crawling the organizational data sources, and extracting from them extracted data that includes at least: user permissions, organizational chart, and access logs; performing semantic analysis of the extracted data, and constructing at least: (i) a first semantic index that reflects user-related organizational context, and (ii) a second semantic index that reflects data-related organizational context.

In some embodiments, the computerized method further comprises: (d) instead of routing the LLM-generated output directly to the querying user, routing the LLM-generated output to a post-processing sanitization unit that checks whether or not the LLM-generated output complies with said pre-defined organizational policy rules.

In some embodiments, the computerized method further comprises: if the post-processing sanitization unit determines that the LLM-generated output does not comply with said pre-defined organizational policy rules, then: performing at said post-processing sanitization unit at least one of: (i) deleting particular portions of the LLM-generated output to make the LLM-generated output compliant with the said pre-defined organizational policy rules; (ii) masking particular portions of the LLM-generated output to make the LLM-generated output compliant with the said pre-defined organizational policy rules.

In some embodiments, the computerized method further comprises: performing a block-or-adapt analysis of (i) said original query, and (ii) the pre-defined organizational policy rules, and (iii) the user-related organizational context, and (iv) the data-related organizational context; based on results of said block-or-adapt analysis, performing one of: (I) blocking the original query from being executed and not generating an adapted query to replace it; or (II) modifying the original query into said adapted query.

In some embodiments, modifying the original query comprises: adding to the original query a set of grounding rules and constraints, that indicate to said LLM that the LLM-generated output should not include a particular type of data.

In some embodiments, the computerized method comprises: producing different LLM-generated outputs, for two or more different users of said organization, that submitted said original query, based on different user-related organizational context that is obtained with regard to each of said users.

In some embodiments, the computerized method comprises: based on the user-related organizational context, selectively causing said LLM to include or to exclude monetary amounts in said LLM-generated output.

In some embodiments, the computerized method comprises: based on the user-related organizational context, selectively causing said LLM to include or to exclude date data in said LLM-generated output.

In some embodiments, the computerized method comprises: based on the user-related organizational context, selectively causing said LLM to include or to exclude passwords or access credentials in said LLM-generated output.

In some embodiments, the computerized method comprises: based on the user-related organizational context, providing to two or more different users LLM-generated outputs that focus on different aspects of a project that is a subject of the original query.

In some embodiments, said pre-defined organizational policy rules comprise one of: (i) LLM constraints that are pre-defined for a particular religious institution, and that limit particular topics and particular keywords that the LLM is authorized to generate in response to queries from particular users of said particular religious institution; (ii) LLM constraints that are pre-defined for a particular educational institution, and that limit particular topics and particular keywords that the LLM is authorized to generate in response to queries from particular users of said particular educational institution; (iii) LLM constraints that are pre-defined for a particular home network, and that limit particular topics and particular keywords that the LLM is authorized to generate in response to queries from particular users of said particular home network. The term “LLM constraints” includes, for example, LLM utilization constraints or rules, LLM access constraints or rules, LLM authorization constraints or rules.

Some embodiments provide a system comprising: one or more hardware processors, that are configured to execute code, and that are operably associated with one or more memory units; wherein the one or more hardware processors are configured to perform a method as described.

Some embodiments provide a non-transitory storage medium having stored thereon instructions that, when executed by a machine, cause the machine to perform a method as described.

Although portions of the discussion herein relate, for demonstrative purposes, to wired links and/or wired communications, some embodiments of the present invention are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be implemented by using hardware units, software units, processors, CPUs, DSPs, GPUs, integrated circuits (ICs), memory units, storage units, wireless communication modems or transmitters or receivers or transceivers, cellular transceivers, a power source, input units, output units, Operating System (OS), drivers, applications, and/or other suitable components.

Some embodiments may be implemented by using a special-purpose machine or a specific-purpose that is not a generic computer, or by using a non-generic computer or a non-general computer or machine. Such system or device may utilize or may comprise one or more units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented by using code or program code or machine-readable instructions or machine-readable code, which is stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such device to perform a method in accordance with the present invention.

Some embodiments may be utilized with a variety of devices or systems having a touch-screen or a touch-sensitive surface; for example, a smartphone, a cellular phone, a mobile phone, a smart-watch, a tablet, a handheld device, a portable electronic device, a portable gaming device, a portable audio/video player, an Augmented Reality (AR) or Virtual Reality (VR) or Mixed Reality (XR) device or headset or gear, a “kiosk” type device, a vending machine, an Automatic Teller Machine (ATM), a laptop computer, a desktop computer, a vehicular computer, a vehicular dashboard, a vehicular touch-screen, or the like.

The system(s) and/or device(s) of some embodiments may optionally comprise, or may be implemented by utilizing suitable hardware components and/or software components; for example, processors, processor cores, Central Processing Units (CPUs), Digital Signal Processors (DSPs), circuits, Integrated Circuits (ICs), controllers, memory units, registers, accumulators, storage units, input units (e.g., touch-screen, keyboard, keypad, stylus, mouse, touchpad, joystick, trackball, microphones), output units (e.g., screen, touch-screen, monitor, display unit, audio speakers), acoustic microphone(s) and/or sensor(s), optical microphone(s) and/or sensor(s), laser or laser-based microphone(s) and/or sensor(s), wired or wireless modems or transceivers or transmitters or receivers, GPS receiver or GPS element or other location-based or location-determining unit or system, network elements (e.g., routers, switches, hubs, antennas), and/or other suitable components and/or modules.

The system(s) and/or devices of some embodiments may optionally be implemented by utilizing co-located components, remote components or modules, “cloud computing” servers or devices or storage, client/server architecture, peer-to-peer architecture, distributed architecture, and/or other suitable architectures or system topologies or network topologies.

In accordance with some embodiments, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit, a Flash drive), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL), BASIC, Visual BASIC, MATLAB, Pascal, HTML, HTML5, CSS, Dart, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

Some embodiments of the present invention may perform steps or operations such as, for example, “determining”, “identifying”, “comparing”, “checking”, “querying”, “searching”, “matching”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range values and/or upper limit value and/or lower limit value and/or maximum value and/or minimum value; a comparison or matching between sensed or measured or calculated data, and one or more values as stored in a look-up table or a legend table or a list of reference value(s) or a database of reference values or ranges; a comparison or matching or searching process which searches for matches and/or identical results and/or similar results and/or sufficiently-close results (e.g., within a pre-defined threshold level of similarity; such as, within 5 percent above or below a pre-defined threshold value), among multiple values or limits that are stored in a database or look-up table; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Repeated use of the phrase “in one embodiment” does not necessarily refer to the same embodiment, although it may. Repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may comprise, or may be implemented by using, an “app” or application which may be downloaded or obtained from an “app store” or “applications store”, for free or for a fee, or which may be pre-installed on a computing device or electronic device, or which may be transported to and/or installed on such computing device or electronic device.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may comprise any possible combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some embodiments have been illustrated and described herein, many modifications, substitutions, changes, and equivalents may occur to those skilled in the art. Accordingly, the claims are intended to cover all such modifications, substitutions, changes, and equivalents.

What is claimed is:

1. A computerized method comprising:
(a) receiving an original prompt that a querying user sends to a Large Language Model (LLM) that is operably connected to organizational data sources of an organization;
(b) instead of executing said original prompt by the LLM, performing:
(b1) obtaining user-related organizational context that pertains to characteristics of the querying user;
(b2) obtaining data-related organizational context that pertains to data from which said LLM is expected to obtain information for responding to the original query;
(b3) obtaining pre-defined organizational policy rules, that indicate which type of users are authorized to access which type of organizational data;
(b4) based on (i) the user-related organizational context, and (ii) the data-related organizational context, and (iii) the pre-defined organizational policy rules,
modifying the original prompt into an adapted prompt;
(c) sending the adapted prompt, and not the original prompt, to the LLM for processing, and obtaining LLM-generated output from said LLM in response to said adapted prompt.

2. The computerized method of claim 1,
wherein step (a) of receiving the original prompt comprises: intercepting the original prompt on a communication path from an electronic device of the querying user to said LLM;
wherein step (b4) of modifying the original prompt comprises: modifying the original prompt on said communication path, wherein only the adapted prompt and not the original prompt is transferred to said LLM for processing.

3. The computerized method of claim 1,
wherein step (a) of receiving the original prompt comprises: receiving the original prompt at said LLM; and transferring the original prompt, without processing the original prompt, to an LLM extension module that performs prompt adaptation operations of steps (b1) through (b4) and then transfers the adapted prompt to said LLM for processing.

4. The computerized method of claim 1,
wherein step (b4) of modifying the original prompt comprises:
constructing the adapted prompt by an Assistive LLM, that is pre-configured or pre-trained or fine-tuned to specialize in prompt engineering and LLM grounding,
wherein the Assistive LLM receives as input: (i) the original prompt, and (ii) the user-related organizational context, and (iii) the data-related organizational context, and (iv) the pre-defined organizational policy rules.

5. The computerized method of claim 1,
wherein obtaining the user-related organizational context comprises:
analyzing organizational data sources, and determining from event audit logs whether the querying user is authorized or unauthorized to access a particular type of data.

6. The computerized method of claim 1,
wherein obtaining the user-related organizational context comprises:
analyzing organizational data sources, and estimating to which peer groups said querying user belongs; and based on belonging or non-belonging of the querying user to one or more particular peer groups, determining whether the querying user is authorized or unauthorized to access a particular type of data.

7. The computerized method of claim 1,
wherein obtaining the user-related organizational context comprises:
analyzing organizational data sources, and estimating whether or not information that is expected to be returned by said LLM in response to the original query, is information that an organizational position of the querying user typically accesses and uses; and if not, then adapting the original query to cause exclusion of said information from the LLM-generated output.

8. The computerized method of claim 1, further comprising:
crawling the organizational data sources, and extracting from them extracted data that includes at least: user permissions, organizational chart, and access logs;
performing semantic analysis of the extracted data, and constructing at least: (i) a first semantic index that reflects user-related organizational context, and (ii) a second semantic index that reflects data-related organizational context.

9. The computerized method of claim 1, further comprising:
(d) instead of routing the LLM-generated output directly to the querying user,
routing the LLM-generated output to a post-processing sanitization unit that checks whether or not the LLM-generated output complies with said pre-defined organizational policy rules.

10. The computerized method of claim 9, further comprising:
if the post-processing sanitization unit determines that the LLM-generated output does not comply with said pre-defined organizational policy rules, then:
performing at said post-processing sanitization unit at least one of:
(i) deleting particular portions of the LLM-generated output to make the LLM-generated output compliant with the said pre-defined organizational policy rules;
(ii) masking particular portions of the LLM-generated output to make the LLM-generated output compliant with the said pre-defined organizational policy rules.

11. The computerized method of claim 1, comprising:
performing a block-or-adapt analysis of (i) said original query, and (ii) the pre-defined organizational policy rules, and (iii) the user-related organizational context, and (iv) the data-related organizational context;
based on results of said block-or-adapt analysis, performing one of: (I) blocking the original query from being executed and not generating an adapted query to replace it; or (II) modifying the original query into said adapted query.

12. The computerized method of claim 1,
wherein modifying the original query comprises:
adding to the original query a set of grounding rules and constraints, that indicate to said LLM that the LLM-generated output should not include a particular type of data.

13. The computerized method of claim 1, comprising:
producing different LLM-generated outputs, for two or more different users of said organization, that submitted said original query,
based on different user-related organizational context that is obtained with regard to each of said users.

14. The computerized method of claim 1, comprising:
based on the user-related organizational context, selectively causing said LLM to include or to exclude monetary amounts in said LLM-generated output.

15. The computerized method of claim 1, comprising:
based on the user-related organizational context, selectively causing said LLM to include or to exclude date data in said LLM-generated output.

16. The computerized method of claim 1, comprising:
based on the user-related organizational context, selectively causing said LLM to include or to exclude passwords or access credentials in said LLM-generated output.

17. The computerized method of claim 1, comprising:
based on the user-related organizational context, providing to two or more different users LLM-generated outputs that focus on different aspects of a project that is a subject of the original query.

18. The computerized method of claim 1,
wherein said pre-defined organizational policy rules comprise one of:
(i) LLM access constraints that are pre-defined for a particular religious institution, and that limit particular topics and particular keywords that the LLM is authorized to generate in response to queries from particular users of said particular religious institution;
(ii) LLM access constraints that are pre-defined for a particular educational institution, and that limit particular topics and particular keywords that the LLM is authorized to generate in response to queries from particular users of said particular educational institution;
(iii) LLM access constraints that are pre-defined for a particular home network, and that limit particular topics and particular keywords that the LLM is authorized to generate in response to queries from particular users of said particular home network.

19. A system comprising:
one or more hardware processors, that are configured to execute code,
and that are operably associated with one or more memory units;
wherein the one or more hardware processors are configured to perform a method comprising:
(a) receiving an original prompt that a querying user sends to a Large Language Model (LLM) that is operably connected to organizational data sources of an organization;
(b) instead of executing said original prompt by the LLM, performing:
(b1) obtaining user-related organizational context that pertains to characteristics of the querying user;
(b2) obtaining data-related organizational context that pertains to data from which said LLM is expected to obtain information for responding to the original query;
(b3) obtaining pre-defined organizational policy rules, that indicate which type of users are authorized to access which type of organizational data;
(b4) based on (i) the user-related organizational context, and (ii) the data-related organizational context, and (iii) the pre-defined organizational policy rules,
modifying the original prompt into an adapted prompt;
(c) sending the adapted prompt, and not the original prompt, to the LLM for processing, and obtaining LLM-generated output from said LLM in response to said adapted prompt.

20. A non-transitory storage medium having stored thereon instructions that, when executed by a machine, cause the machine to perform a method comprising:
(a) receiving an original prompt that a querying user sends to a Large Language Model (LLM) that is operably connected to organizational data sources of an organization;
(b) instead of executing said original prompt by the LLM, performing:
(b1) obtaining user-related organizational context that pertains to characteristics of the querying user;
(b2) obtaining data-related organizational context that pertains to data from which said LLM is expected to obtain information for responding to the original query;
(b3) obtaining pre-defined organizational policy rules, that indicate which type of users are authorized to access which type of organizational data;
(b4) based on (i) the user-related organizational context, and (ii) the data-related organizational context, and (iii) the pre-defined organizational policy rules,
modifying the original prompt into an adapted prompt;
(c) sending the adapted prompt, and not the original prompt, to the LLM for processing, and obtaining LLM-generated output from said LLM in response to said adapted prompt.
